(19) United States
(12) Patent Application Publication
(10) Pub. No.: US 2012/0081679 A1
(43) Pub. Date: Apr. 5, 2012

(54) LIGHT SOURCE APPARATUS AND PROJECTION DISPLAY APPARATUS

(75) Inventor: Shinya Matsumoto, Uji-City (JP)

(73) Assignee: SANYO ELECTRIC CO., LTD., Osaka (JP)

(21) Appl. No.: 13/250,411

(22) Filed: Sep. 30, 2011

(30) Foreign Application Priority Data
Sep. 30, 2010 (JP) 2010-223271

(51) Int. Cl. G03B 21/28; F21V 7/00

(52) U.S. Cl. 353/98; 362/235

(57) ABSTRACT

A light source apparatus includes: a light source unit; a light guiding reflection mirror; a reflector; and a luminous body unit. The luminous body unit includes: a luminous body and a reflecting body. The plurality of light sources are disposed around a position corresponding to an axis on which the luminous body unit is disposed.

### CROSS REFERENCE TO RELATED APPLICATIONS

This application is based upon and claims the benefit of priority from prior Japanese Patent Application No. 2010-223271, filed on Sep. 30, 2010, the entire contents of which are incorporated herein by reference.

### BACKGROUND OF THE INVENTION

1. Field of the Invention

The present invention relates to a light source apparatus and a projection display apparatus which include a light source that emit excitation light and a luminous body that emits predetermined color component light according to the excitation light.

2. Description of the Related Art

Conventionally, there is known a projection display apparatus including an imager that modulates light emitted from a light source and a projection unit that projects the light emitted from the imager onto a projection surface.

There is proposed a projection display apparatus including a luminous body which emits fundamental image light such as red component light, green component light, and blue component light, using as excitation light emitted from the light source (for example, JP-A-2007-156270). Specifically, the luminous body is disposed in vicinity to the focal point position of a reflector including a parabolic reflection surface so that excitation light reflected by the reflector is focused on the luminous body.

Such a projection display apparatus described above requires, for example, a substrate to dispose the luminous body thereon and a light reflecting member to utilize excitation light effectively. In such a case, light (excitation light) emitted from the light source is undesirably shielded by the substrate and the light reflecting member before the reflector reflects the light (excitation light) emitted from the light source. In other words, the usage efficiency of the light (excitation light) emitted from the light source is decreased.

### SUMMARY OF THE INVENTION

A light source apparatus according to a first feature includes: a light source unit (light source unit 10) including a plurality of light sources that emits excitation light; a light guiding reflection mirror (light guiding reflection mirror 40) including a light guiding reflection surface that reflects the excitation light emitted from the light source unit; a reflector (reflector 50) including a reflection surface that reflects the excitation light reflected by the light guiding reflection mirror; and a luminous body unit (luminous body unit 60) arranged in vicinity to a focal point position of the reflector. The luminous body unit includes: a luminous body (luminous body 61G, for example) that emits fundamental image light in accordance with the excitation light reflected by the reflector; and a reflecting body (mirror film 63) that reflects to a side of the reflector, the fundamental image light emitted from the luminous body. The reflection surface reflects to a side of the light guiding reflection mirror, the fundamental image light reflected by the reflecting body. The light guiding reflection surface transmits the fundamental image light reflected by the reflecting surface. The plurality of light sources are disposed around a position corresponding to an axis on which the luminous body unit is disposed.

A light source apparatus according to a second feature includes: a light source unit (light source unit 10) including a plurality of light sources that emits excitation light; a light guiding reflection mirror (light guiding reflection mirror 40) including a light guiding reflection surface that reflects the excitation light emitted from the light source unit; a tapered rod (tapered rod 150) arranged on an optical path of the excitation light reflected by the light guiding reflection mirror, the tapered rod including an incidence end on which the excitation light is incident and an emission end from which the excitation light is emitted; and a luminous body unit (luminous body unit 60) arranged in the emission end. The luminous body unit includes: a luminous body (luminous body 61G) that emits fundamental image light in accordance with excitation light reflected by the light guiding refection mirror; and a reflecting body (mirror film 63) that reflects to a side of the light guiding reflection mirror, the fundamental image light emitted from the luminous body. The light guiding reflection surface transmits the fundamental image light reflected by the reflecting body. The plurality of light sources are disposed around a position corresponding to an axis on which the luminous body unit is disposed.

In the first feature or the second feature, the light source apparatus includes: a lens unit (fly-eye lens unit 20) including a plurality of lenses that focuses the excitation light emitted from the light source unit. The plurality of lenses are disposed around the position corresponding to the axis on which the luminous body unit is disposed, and the plurality of lenses correspond to the plurality of light sources, respectively.

In the first feature or the second feature, the light source unit is configured by a first light source unit (first light source unit 10A) and a second light source unit (second light source unit 10B), the first light source unit including a plurality of first light sources that emits first polarized excitation light (P-polarized excitation light, for example), the second light source unit including a plurality of second light sources that emit second polarized excitation light (S-polarized excitation light, for example). A combining unit combines the first polarized excitation light emitted from the first light source unit and the second polarized excitation light emitted from the second light source unit, and is arranged on an optical path of excitation light emitted from the light source unit, between the light source unit and the light guiding reflection mirror. The plurality of first light sources and the plurality of second light sources are disposed so that the first polarized excitation light and the second polarized excitation light are alternately arranged in a circular form around the position corresponding to the axis on which the luminous body unit is disposed, after the lights are combined by the combining unit.

In the first feature or the second feature, the luminous body unit is configured by a rotating drum or a rotating wheel that supports the luminous body in a rotatable manner.

In the first feature or the second feature, the luminous body unit is configured by a swinging body that supports the luminous body in a swingable manner in accordance with a position on which the excitation light is focused by the lens unit.

A projection display apparatus according to a third feature includes: the light source apparatus according to the first feature of the second feature; an imager that modulates light emitted from the light source apparatus; and a projection unit that projects light emitted from the imager.

### BRIEF DESCRIPTION OF THE DRAWINGS

FIG. 1 is a diagram illustrating a light source apparatus 100 according to a first embodiment.

FIG. 2 is a diagram illustrating a first light source unit 10A according to the first embodiment.

FIG. 3 is a diagram illustrating a second light source unit 10B according to the first embodiment.

FIG. 4 is a diagram illustrating a fly eye lens unit 20 according to the first embodiment,

FIG. 5 is a diagram illustrating the fly eye lens unit 20 according to the first embodiment.

FIG. 6 is a diagram illustrating the fly eye lens unit 20 according to the first embodiment.

FIG. 7 is a diagram illustrating the fly eye lens unit 20 according to the first embodiment.

FIG. 8 is a diagram for explaining disposition of color component light of P-polarization and S-polarization according to the first embodiment.

FIG. 9 is a diagram illustrating a luminous body unit 60 according to the first embodiment.

FIG. 10 is a diagram illustrating the luminous body unit 60 according to the first embodiment.

FIG. 11 is a diagram illustrating a light source apparatus 100 according to a first modification.

FIG. 12 is a diagram illustrating a luminous body unit 160 according to the first modification.

FIG. 13 is a diagram illustrating the luminous body unit 160 according to the first modification.

FIG. 14 is a diagram illustrating the luminous body unit 160 according to the first modification.

FIG. 15 is a diagram illustrating the light source apparatus 100 according a second modification.

FIG. 16 is a diagram for explaining deposition of each color component light according to the second modification.

FIG. 17 is a diagram illustrating a luminous body unit 260 according to the second modification.

FIG. 18 is a diagram illustrating the luminous body unit 260 according to the second modification.

FIG. 19 is a diagram illustrating a light source apparatus 100 according to a third modification.

FIG. 20 is a diagram for explaining swing of a luminous body unit 60 according to a fourth modification.

FIG. 21 is a diagram for explaining swing of the luminous body unit 60 according to the fourth modification

FIG. 22 is a diagram for explaining swing of the luminous body unit 60 according to the fourth modification.

FIG. 23 is a diagram for explaining swing of the luminous body unit 60 according to the fourth modification.

FIG. 24 is a diagram for explaining swing of the luminous body unit 60 according to the fourth modification.

FIG. 25 is a diagram illustrating a projection display apparatus 300 according to the second embodiment.

FIG. 26 is a diagram illustrating a projection display apparatus 300 according to the first modification.

FIG. 27 is a diagram illustrating a projection display apparatus 300 according to a second modification.

FIG. 28 is a diagram illustrating a projection display apparatus 300 according to a third modification.

FIG. 29 is a diagram illustrating a projection display apparatus 300 according to a fourth modification.

FIG. 30 is a diagram for explaining combination of light according to another embodiment.

FIG. 31 is a diagram for explaining combination of light according to another embodiment.

### DETAILED DESCRIPTION OF THE EMBODIMENTS

Hereinafter, a light source apparatus and a projection display apparatus according to the present invention are explained with reference to drawings. In the following drawings, same or similar parts are denoted with same or similar reference numerals.

However, it should be noted that the drawings are merely exemplary and ratios of each dimension differ from the actual ones. Therefore, the specific dimensions, etc., should be determined in consideration of the following explanations. Moreover, it is needless to say that relations and ratios among the respective dimensions differ among the diagrams.

### Overview of Embodiments

A light source apparatus according to an embodiment includes a light source unit including a plurality of light sources that emits excitation light; a light guiding reflection mirror including a light guiding reflection surface that reflects the excitation light emitted from the light source unit; a reflector including a reflection surface that reflects the excitation light reflected by the light guiding reflection mirror; and a luminous body unit arranged in vicinity to a focal point position of the reflector. The luminous body unit includes a luminous body that emits fundamental image light in accordance with the excitation light reflected by the reflector; and a reflecting body that reflects to a side of the reflector, the fundamental image light emitted from the luminous body. The reflection surface reflects to a side of the light guiding reflection mirror, the fundamental image light reflected by the reflecting body. The light guiding reflection surface transmits the fundamental image light reflected by the reflecting surface. The plurality of light sources are disposed around a position corresponding to an axis on which the luminous body unit is disposed.

A light source apparatus according to an embodiment includes a light source unit including a plurality of light sources that emits excitation light; a light guiding reflection mirror including a light guiding reflection surface that reflects the excitation light emitted from the light source unit; a tapered rod arranged on an optical path of the excitation light reflected by the light guiding reflection mirror, the tapered rod including an incidence end on which the excitation light is incident and an emission end from which the excitation light is emitted; and a luminous body unit arranged in the emission end. The luminous body unit includes a luminous body that emits fundamental image light in accordance with excitation light reflected by the light guiding refection mirror; and a reflecting body that reflects to a side of the light guiding reflection mirror, the fundamental image light emitted from the luminous body. The light guiding reflection surface transmits the fundamental image light reflected by the reflecting body. The plurality of light sources are disposed around a position corresponding to an axis on which the luminous body unit is disposed.

According to an embodiment, a plurality of light sources arranged in a light source unit are disposed around the position corresponding to the axis on which a luminous body unit is disposed. Therefore, the light emitted from the plurality of light sources is not shielded by the luminous body unit, so that the usage efficiency of light (excitation light) emitted from the light sources can be improved.

### First Embodiment

### (Light Source Apparatus)

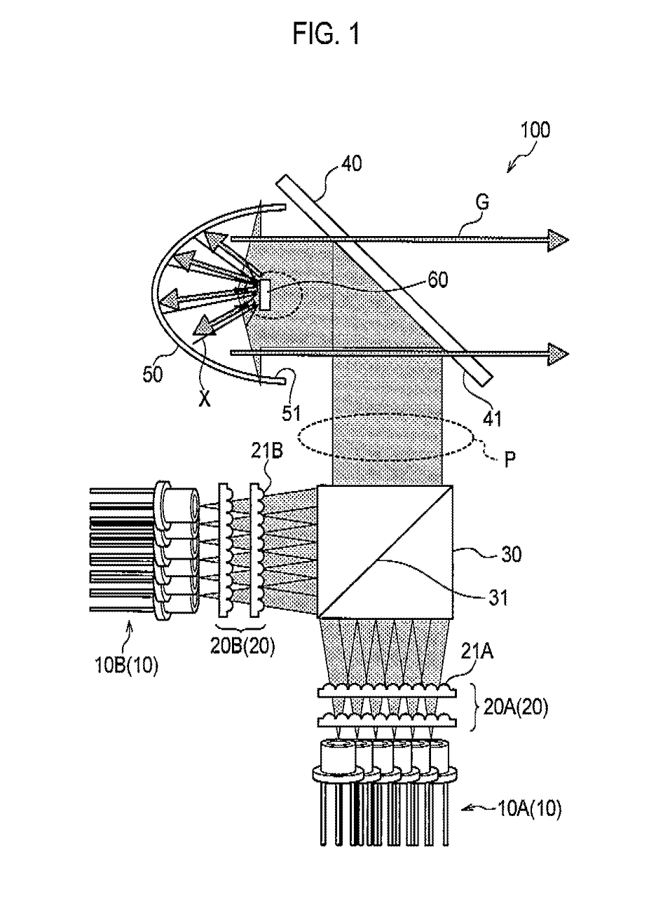

Hereinafter, the light source apparatus according to a first embodiment is explained with reference to drawings. FIG. 1 is a diagram illustrating a light source apparatus 100 according to the first embodiment. It is noted that the first embodiment describes as an example, a case where red component light R, green component light G, and blue component light B are utilized as fundamental image light.

As illustrated in FIG. 1, the light source apparatus 100 includes a light source unit 10, a fly eye lens unit 20, a PBS cube 30, a light guiding reflection mirror 40, a reflector 50, and a luminous body unit 60.

The light source unit 10 is configured by a first light source unit 10A and a second light source unit 10B.

The first light source unit 10A includes a plurality of light sources 11A emits excitation light. Examples of the light source 11A include an LD (Laser Diode) and LED (Light Emitting Diode).

Examples of the excitation light include blue component light B and ultraviolet component light UV. The light sources 11A arranged in the first light source unit 10A emit P-polarized excitation light, for example. It is noted that the excitation light is defined as a light having a function of exciting fundamental image light. For example, in a case of using the blue component light B as excitation light, it is noted that the blue component light B is utilized as fundamental image light as well.

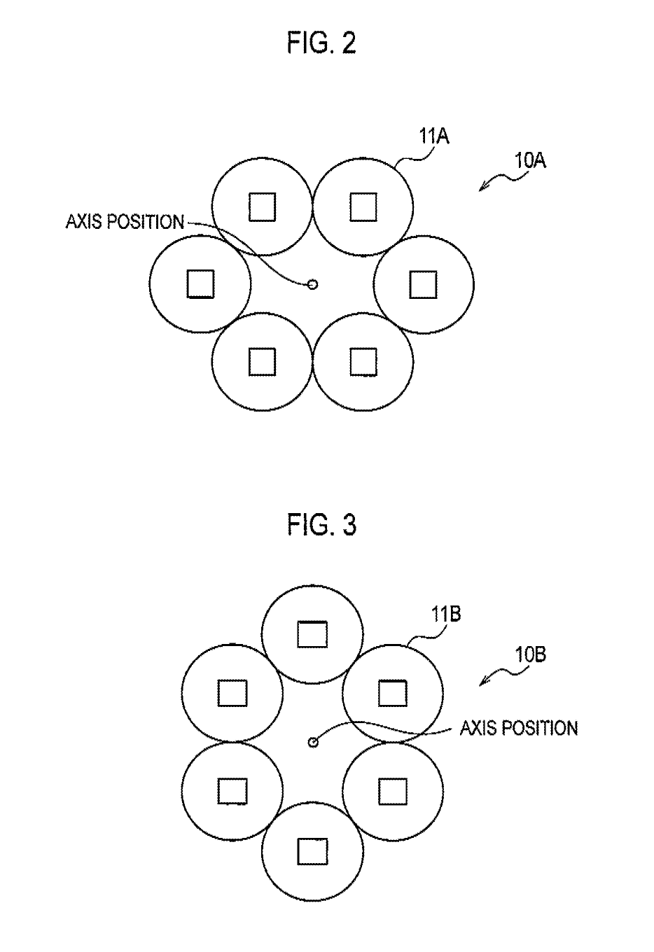

Herein, as illustrated in FIG. 2, the plurality of light sources 11A are disposed around a position (axis position) corresponding to an axis on which a luminous body unit 60 described later is disposed. For example, the plurality of light sources 11A are disposed in a circular form around the axis position as the center.

The second light source unit 10B includes a plurality of light sources 11B emits excitation light. Examples of the light source 11B includes an LD (Laser Diode) and LED (Light Emitting Diode). Examples of the excitation light include the blue component light B and ultraviolet component light UV. Herein, the light sources 11B arranged in the second light source unit 10B emit S-polarized excitation light, for example.

Herein, as illustrated in FIG. 3, the plurality of light sources 11B are disposed around the position (axis position) corresponding to the axis on which the luminous body unit 60 described later is disposed. For example, the plurality of light sources 11B are disposed in a circular form around the axis position as the center.

It is noted that, the plurality of light sources 11A and the plurality of light sources 11B are disposed so that, after combination of the P-polarized excitation light emitted from the first light source unit 10A and the S-polarized excitation light emitted from the second light source unit 10B, the P-polarized excitation light and the S-polarized excitation light are alternately arranged in a circular form around the position (axis position) corresponding to the axis on which the luminous body unit 60 is disposed.

The fly eye lens unit 20 is configured by a first fly eye lens unit 20A and a second fly eye lens unit 20B.

The first fly eye lens unit 20A is configured by a plurality of micro-lenses 21A. Each of the micro-lenses 21A maintains a path of P-polarized excitation light emitted from the first light source unit 10A so that the reflector 50, not the luminous body unit 60, is irradiated with the P-polarized excitation light.

The plurality of micro-lenses 21A are disposed, likewise the plurality of light sources UA, around the position (axis position) corresponding to the axis on which the luminous body unit is disposed. For example, the plurality of micro-lenses 21A are disposed in a circular form around the axis position as the center. The plurality of micro-lenses 21A correspond to the plurality of light sources 11A, respectively.

The second fly eye lens unit 20B is configured by a plurality of micro-lenses 21B. Each of the micro-lenses 21B maintains a path of S-polarized excitation light emitted from the second light source unit 10B so that the reflector 50, not the luminous body unit 60, is irradiated with the S-polarized excitation light.

The fly eye lens unit 20 is described by citing as an example, the first fly eye lens unit 20A.

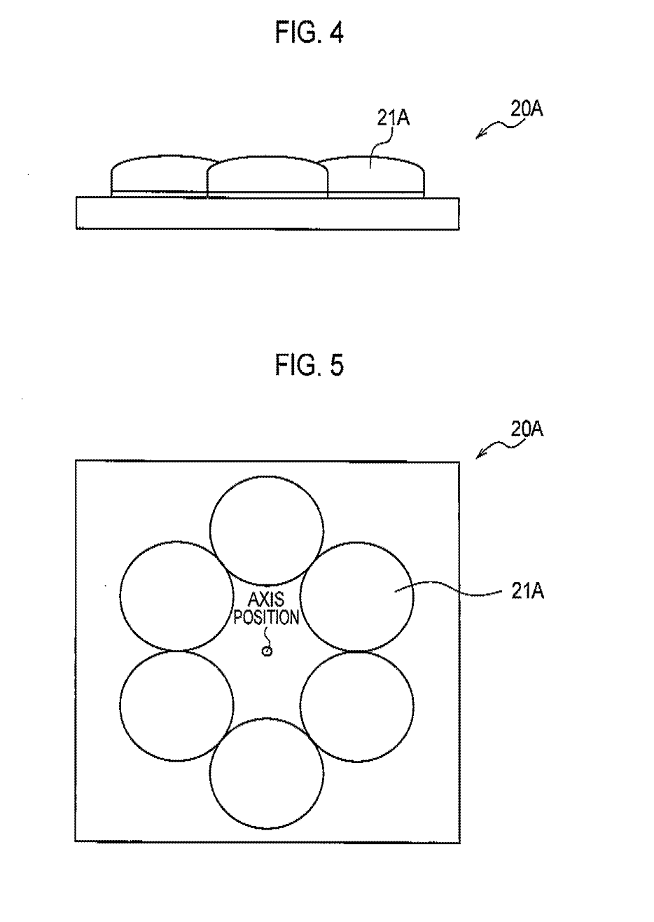

Specifically, each of the micro-lenses 21A arranged in the first fly eye lens unit 20A may be a convex lens focuses excitation light, as illustrated in FIGS. 4 and 5. It is noted that FIG. 4 illustrates the first fly eye lens unit 20A when viewed from a lateral side while FIG. 5 illustrates the first fly eye lens unit 20A when viewed from a top side.

As illustrated in FIG. 5, it is noted that the plurality of micro-lenses 21A have the same array as that of the plurality of light sources 11A. The plurality of micro-lenses 21A correspond to the plurality of light sources 11A, respectively.

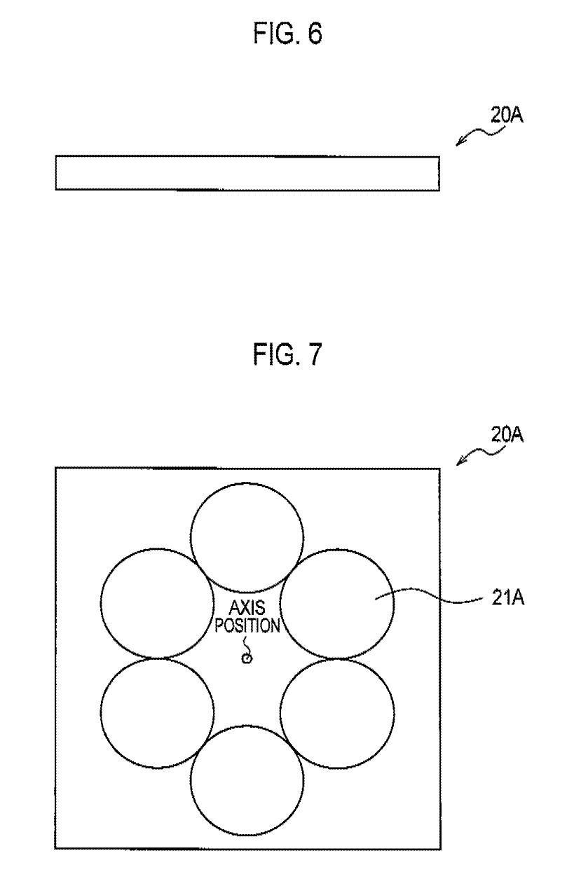

Alternatively, each of the micro-lenses 21A arranged in the first fly eye lens unit 20A may be a diffractive lens diffracts excitation light, as shown in FIGS. 6 and 7. It is noted that FIG. 6 illustrates the first fly eye lens unit 20A when viewed from a lateral side while FIG. 7 illustrates the first fly eye lens unit 20A when viewed from a top side.

As illustrated in FIG. 7, it is noted that the plurality of micro-lenses 21A have the same array as that of the plurality of light sources 11A. The plurality of micro-lenses 21A correspond to the plurality of light sources 11A, respectively.

The second fly eye lens unit 20B includes the same configuration as that of the first fly eye lens unit 20A, so that detailed description of the second fly eye lens unit 20B is omitted.

The PBS cube 30 is disposed between the light source unit 10 and the light guiding reflection mirror 40 on an optical path of excitation light emitted from the light source unit 10. Specifically, the PBS cube 30 includes a PBS surface 31. The PBS surface 31 transmits the P-polarized excitation light and reflects the S-polarized excitation light. That is, the PBS cube 30 combines the P-polarized excitation light with the S-polarized excitation light.

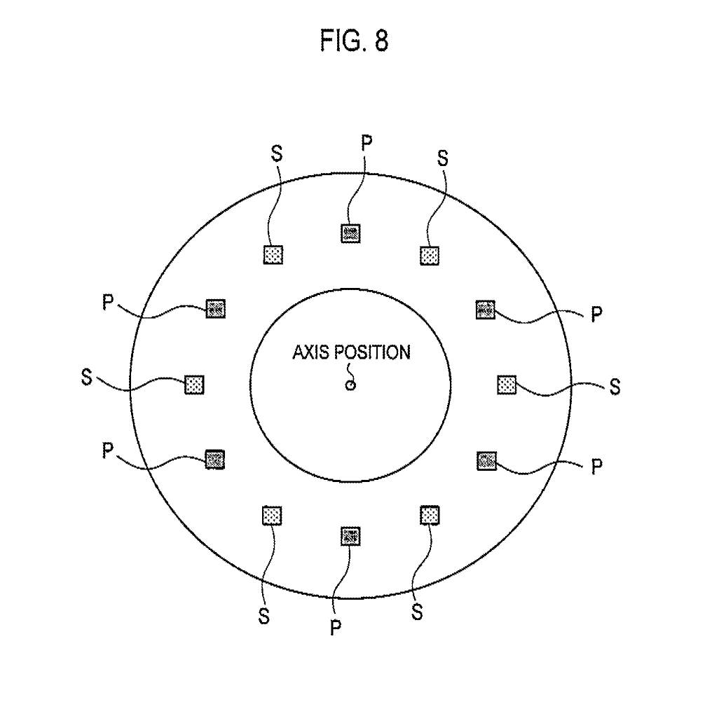

Herein, the P-polarized excitation light and the S-polarized excitation light are, after being combined by the PBS cube 30, alternately arranged in a circular form around the axis position, as illustrated in FIG. 8. It is noted that FIG. 5 illustrates disposition of the P-polarized light and the S-polarized light in region P.

The light guiding reflection mirror 40 includes a light guiding reflection surface 41 reflects excitation light emitted from the light source unit 10. Examples of the light guiding reflection surface 41 include a dichroic mirror surface. Specifically, the light guiding reflection mirror 41 reflects to the reflector 50 side, excitation light emitted from the light source unit 10. On the other hand, the light guiding reflection surface 41 transmits the fundamental image light (herein, green component light G) reflected by the reflector 50. It is noted that the fundamental image light reflected by the reflector 50 is emitted from the luminous body unit 60 in accordance with excitation light, as explained later.

The reflector 50 includes a parabolic reflection surface 51. The parabolic reflection surface 51 reflects excitation light reflected by the light guiding reflection mirror 40. The excitation light reflected by the parabolic reflection surface 51 is focused on the focal point position of the parabolic reflection surface 51. Furthermore, the parabolic reflection surface 51 reflects to the light guiding reflection mirror 40 side, the fundamental image light emitted from the luminous body unit 60 in accordance with excitation light.

The luminous body unit 60 is arranged in vicinity to the focal point position of the reflector 50 (parabolic reflection surface 51). The luminous body unit 60 includes a luminous body and a reflecting body in order of distance from the reflector 50, in which the luminous body emits fundamental image light in accordance with excitation light reflected by the reflector 50, and the reflecting body reflects to the reflector side, the fundamental image light emitted from the luminous body.

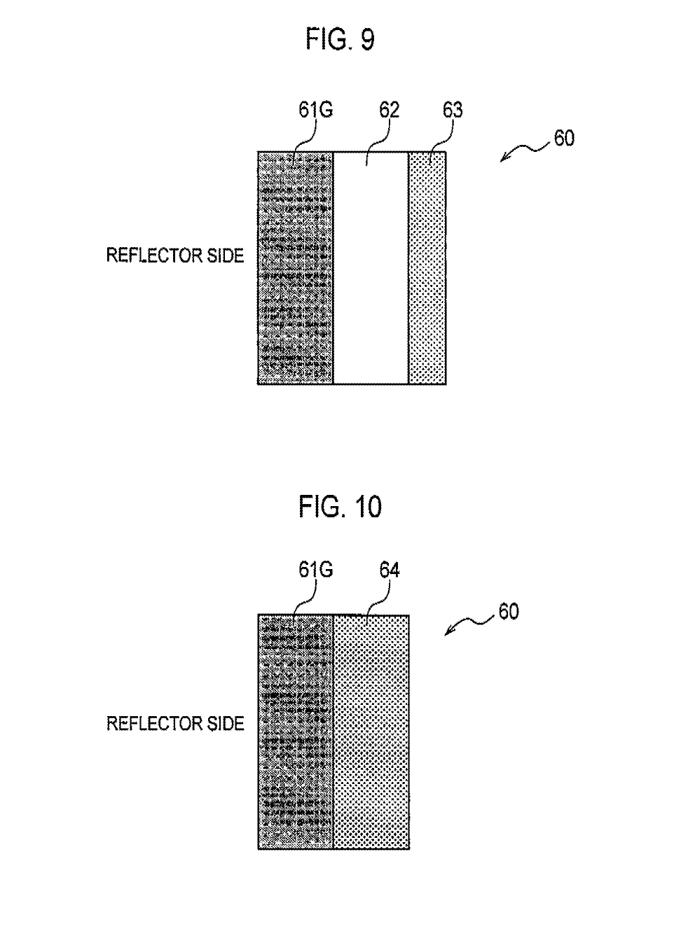

Specifically, the luminous body unit 60 includes a luminous body 61G, a substrate 62, and a mirror film 63, as illustrated in FIG. 9. The luminous body 61G emits fundamental image light (herein, green component light G) in accordance with excitation light. The substrate 62 is configured by a transparent member such as glass. The mirror film 63 reflects fundamental image light (herein, green component light G) emitted from the luminous body 61G.

Alternatively, the luminous body unit 60 includes the luminous body 61G and a substrate 64, as illustrated in FIG. 10. The luminous body 61G emits fundamental image light (herein, green component light G) in accordance with excitation light. The substrate 64 is configured by a member (such as aluminum) reflects fundamental image light (herein, green component light G) emitted from the luminous body 61G.

### (Operation and Effect)

In the first embodiment, the plurality of light sources arranged in the light source unit 10 are disposed around the position (axis position) corresponding to the axis on which the luminous body unit 60 is disposed. Therefore, light emitted from the plurality of light sources is not shielded by the luminous body unit 60, so that the usage efficiency of the light (excitation light) emitted from the light sources can be improved.

In the first embodiment, the plurality of micro-lenses arranged in the fly eye lens unit 20 are disposed around the center which is sent to a position (axis position) corresponding to the axis on which the luminous body unit 60 is disposed. Furthermore, the plurality of micro-lenses correspond to the plurality of light sources arranged in the light source unit 10, respectively. Therefore, a path of light (excitation light) emitted from the light sources can be maintained so the luminous body unit 60 as to be prevented from being irradiated with the light emitted from the light sources.

In the first embodiment, the plurality of light sources 11A and the plurality of light sources 11B are disposed so that the P-polarized excitation light and the S-polarized excitation light are alternately arranged in a circular form around the position (axis position) corresponding to the axis on which the luminous body unit 60 is disposed. Therefore, a light density after combination can be increased without the necessity of densely disposing the plurality of light sources 11A (or the plurality of light sources 11B). Furthermore, since the plurality of light sources 11A (or the plurality of light sources 11B) are not densely disposed, heat sources can be dispersed, thereby improving the cooling efficiency.

### [First Modification]

Hereinafter, a first modification of the first embodiment is explained. The explanation below is based on the differences with respect to the first embodiment.

Specifically, the luminous body unit is a plate-shaped member in the first embodiment while being a rotating drum in the first modification.

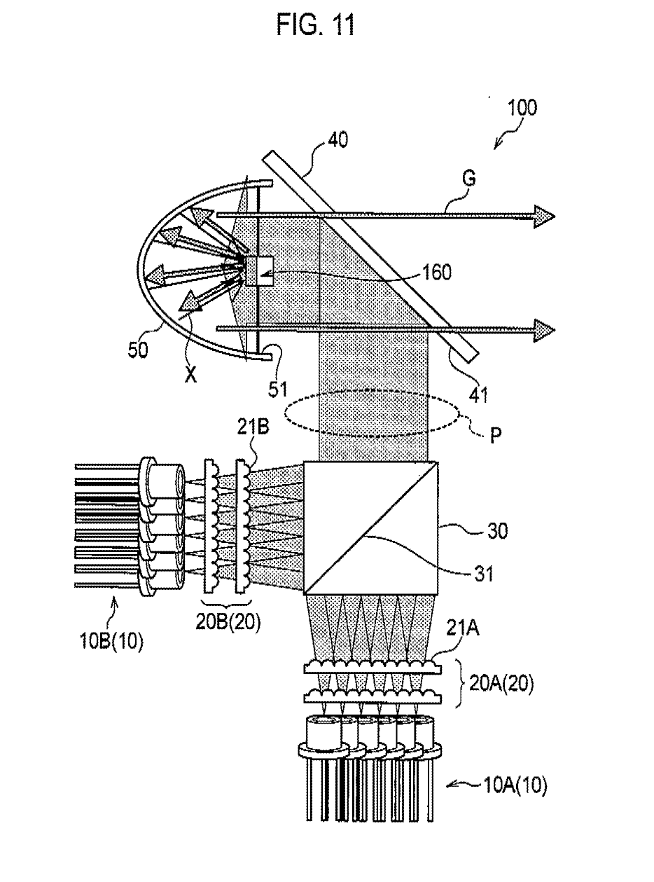

In more detail, the light source apparatus 100 according to the first modification includes a luminous body unit 160 instead of the luminous body unit 60, as illustrated in FIG. 11. It is noted that in FIG. 11, similar reference numerals are denoted to components similar to those in FIG. 1.

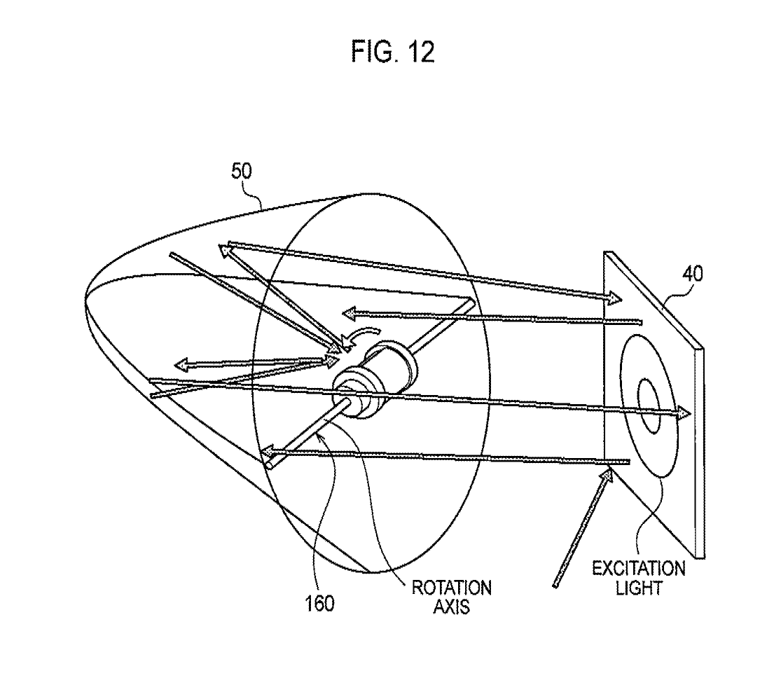

The luminous body unit 160 is a rotating drum configured so as to be rotatable with the rotation axis being set as the center, as illustrated in FIG. 12.

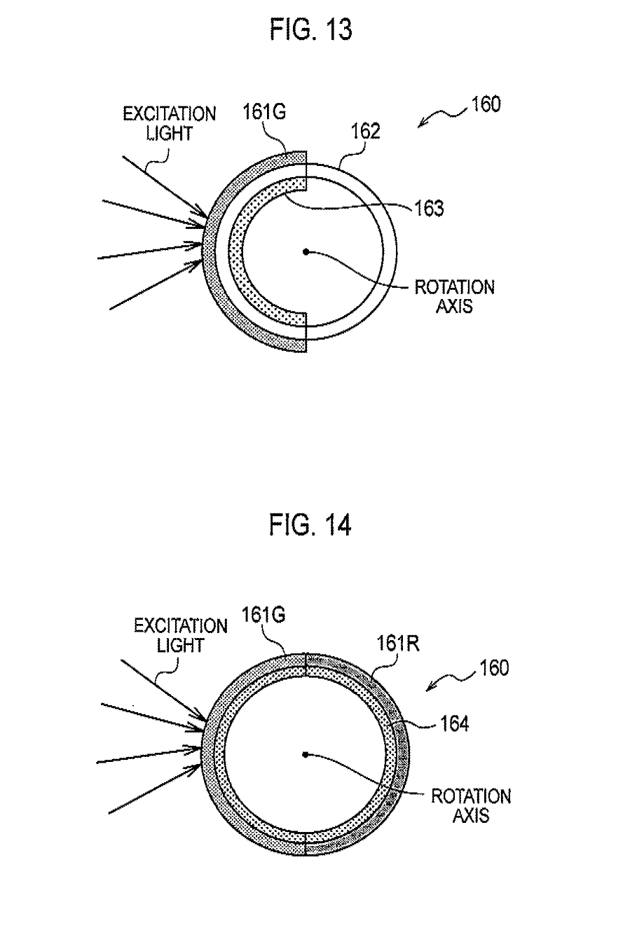

Specifically, the luminous body unit 160 includes a luminous body 161G, a drum main body 162, and a mirror film 163, as illustrated in FIG. 13. The luminous body 161G is arranged on an outer surface of the drum main body 162 and emits fundamental image light (herein, green component light G) according to excitation light. The drum main body 162 is configured so as to be rotatable with the rotation axis being set as the center, and is configured by a transparent member such as glass. The mirror film 163 is arranged on an inner surface of the drum main body 162 and reflects fundamental image light (herein, green component light G) emitted from the luminous body 61G.

Alternatively, in a case of arranging two types of luminous bodies, the luminous body unit 160 may have a configuration illustrated in FIG. 14. Specifically, the luminous body unit 160 includes the luminous body 161G, a luminous body 161R, and a drum main body 164, as illustrated in FIG. 14. The luminous body 161G emits fundamental image light (herein, green component light G) according to excitation light. The luminous body 161R emits fundamental image light (red component light R) according to excitation light. The drum main body 164 is configured so as to be rotatable with the rotation axis being set as the center, and is configured by a member (such as aluminum) reflects fundamental image light emitted from the luminous body 161G or the luminous body 161R.

### (Operation and Effect)

In the first modification, the luminous body unit is a rotating drum. This makes it easy to limit a time period for irradiating the luminous body 161G with excitation light, thereby restraining degradation of the luminous body 161G.

### [Second Modification]

Hereinafter, a second modification of the first embodiment is explained. The explanation below is based on the differences with respect to the first embodiment.

Specifically, the luminous body unit is a plate-shaped member in the first embodiment while being a rotating wheel in the second modification.

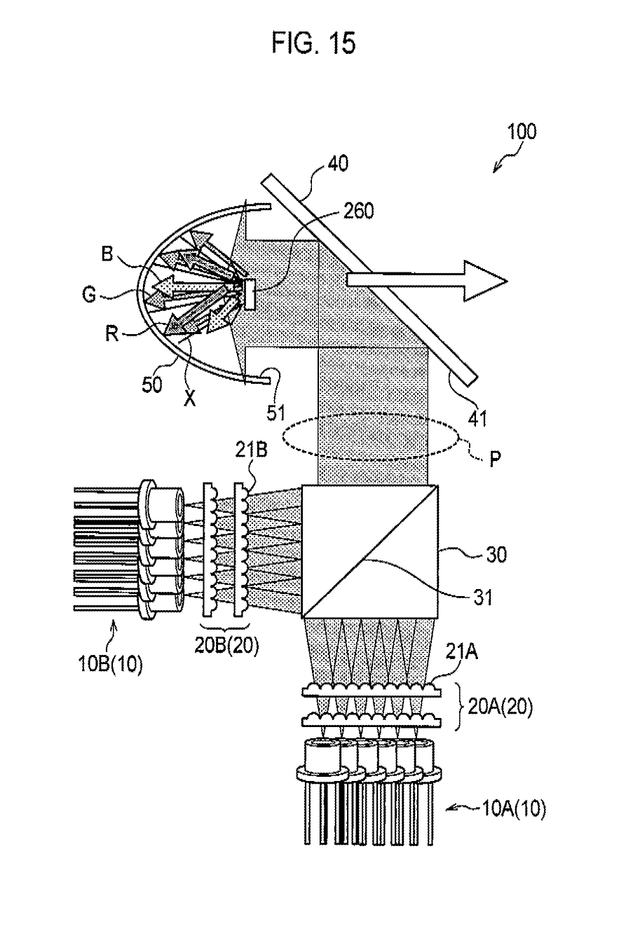

In more detail, the light source apparatus 100 according to the second modification includes a luminous body unit 260 instead of the luminous body unit 60, as illustrated in FIG. 15. It is noted that in FIG. 15, similar reference numerals are denoted to components similar to those in FIG. 1.

In the second modification, the blue component light B is utilized as excitation light, and an explained example is a case where the red component light R and the green component light G are emitted in accordance with excitation light.

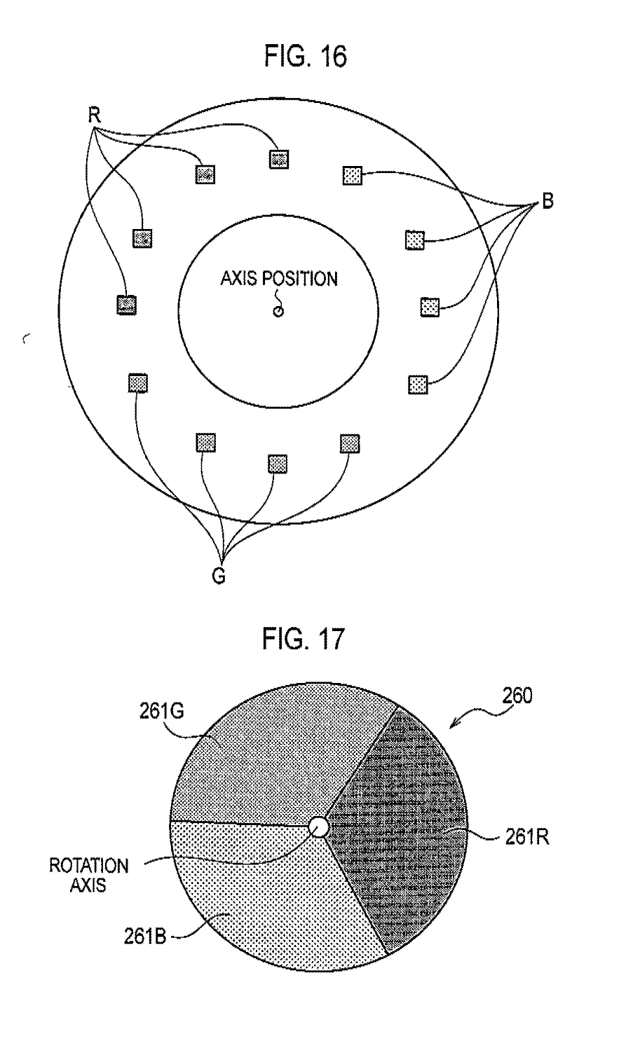

Herein, after the P-polarized excitation light and the S-polarized excitation light are combined by the PBS cube 30, light R (excitation light) intended for the red component light R, light G (excitation light) intended for the green component light G, and light B (excitation light) intended for the blue component light B are arranged as illustrated in FIG. 16. That is, the light R for the red component light R, the light G for the green component light G, and the light B for the blue component light B are segmentally disposed in accordance with positions of a luminous body and a diffuser plate arranged in the luminous body unit 260 (rotating wheel). It is noted that FIG. 16 illustrates disposition of the light R for the red component light R, the light G for the green component light 0, and the light B for the blue component light B in region P.

The luminous body unit 260 is configured so as to be rotatable with the rotation axis being set as the center, and includes a luminous body 261G, a luminous body 261R, and a diffuser plate 261B, as illustrated in FIG. 17. The luminous body 261G emits fundamental image light (herein, green component light G) according to the light G (excitation light) for the green component light G. The luminous body 261R emits fundamental image light (herein, the red component light R) according to the light R (excitation light) for the red component light R. The diffuser plate 261B diffuses the light B for the blue component light B.

It goes without saying that timing of illuminating the light R for the red component light R, the light G for the green component light G, and the light B for the blue component light B is synchronized with rotation of the luminous body unit 260.

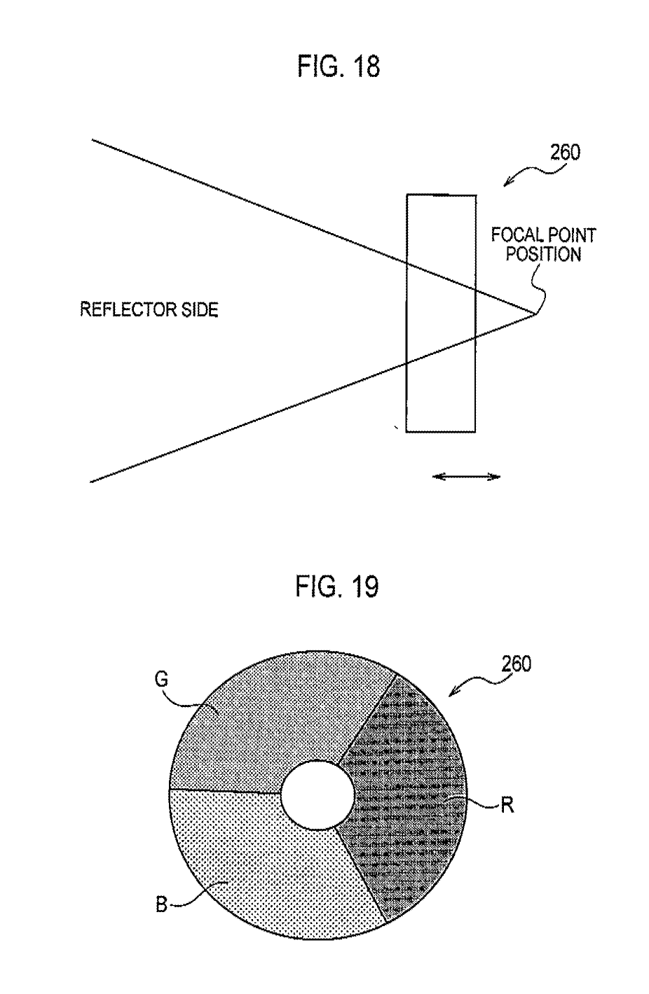

Furthermore, it is desirable that the luminous body unit 26 be disposed in a position deviated from the focal point position of the reflector 50 toward the reflector 50 side, as illustrated in FIG. 18. In this manner, as illustrated in FIG. 19, the vicinity of the rotation axis of the luminous body unit 260 is not irradiated with light, so that the light R for the red component light R, the light G for the green component light G, and the light B for the blue component light B can be restrained from being intermixed.

It is noted that, in a configuration that excitation light is the ultraviolet component light UV and that the blue component light B is emitted in accordance with the ultraviolet component light UV, a luminous body emits the blue component light B in accordance with the ultraviolet component light UV is arranged instead of the diffuser plate 261B.

### [Third Modification]

Hereinafter, a third modification of the first embodiment is explained. The explanation below is based on the differences with respect to the first embodiment.

Specifically, the luminous body unit is arranged in vicinity to the focal point position of the reflector in the first embodiment while being disposed at an end of a tapered rod in the third modification.

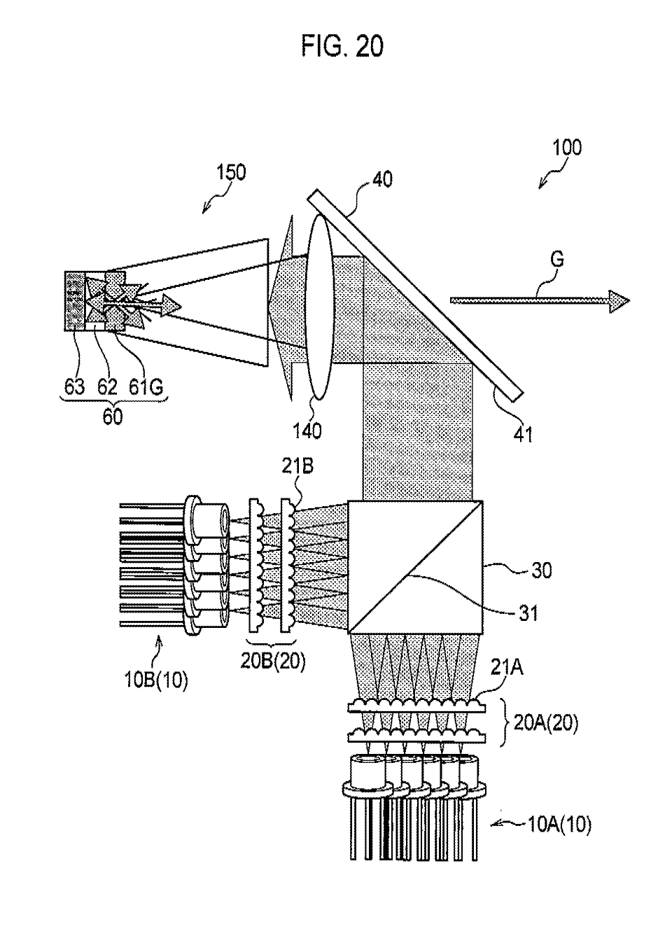

In more detail, the light source apparatus 100 according to the third modification includes a lens 140, as illustrated in FIG. 20. The light source apparatus 100 includes a tapered rod 150 instead of the reflector 50. It is noted that in FIG. 20, similar reference numerals are denoted to components similar to those in FIG. 1.

The lens 140 focuses light on the luminous body unit 60 (luminous body 61G) arranged in the end of the tapered rod 150. It is desirable that an angle at which the light focused by the lens 140 is incident on the luminous body unit 60 (luminous body 61G) be approximately equal to an inclination angle of a light reflecting surface of the tapered rod 150.

The tapered rod 150 has a tapered shape which gradually expands toward the light guiding reflection mirror 40. The tapered rod 150 includes an incidence end on which excitation light is incident (that is, an end from which the green component light G is emitted) and an emission end from which excitation light is emitted (that is, an end on which the green component light G is incident). The emission end of the taper rod 150 is provided with the luminous body unit 60.

The luminous body unit 60 includes the luminous body 61G and the substrate 62 in order of distance from the light guiding reflection mirror 40. It is noted that the luminous body 61G and the substrate 62 in the third modification are lined up in reverse order to those illustrated in FIG. 10.

Furthermore, likewise the first embodiment, the luminous body unit 60 may be configured by the luminous body 61G, the substrate 64, and the mirror film 63 (see FIG. 9). In such a case, the luminous body unit 60 includes the luminous body 61G, the substrate 64, and the mirror film 63 in order of distance form the light guiding reflection mirror 40.

### [Fourth Modification]

Hereinafter, a fourth modification of the first embodiment is explained. The explanation below is based on the differences with respect to the third modification.

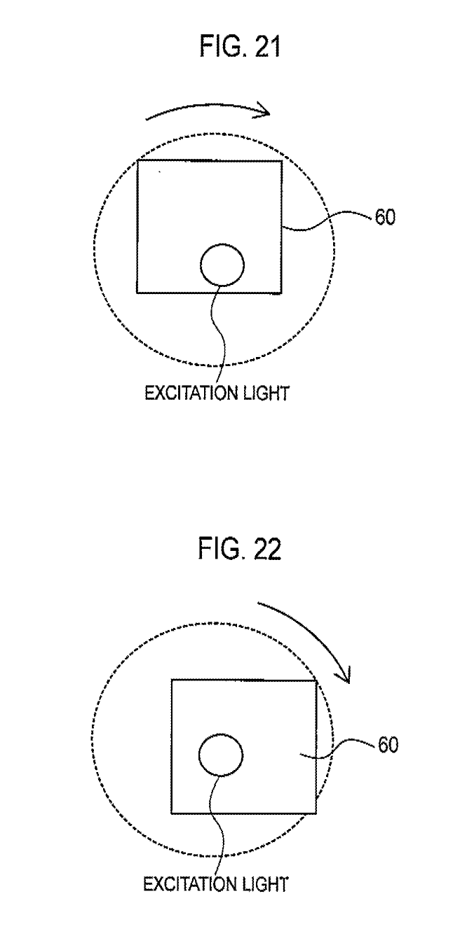

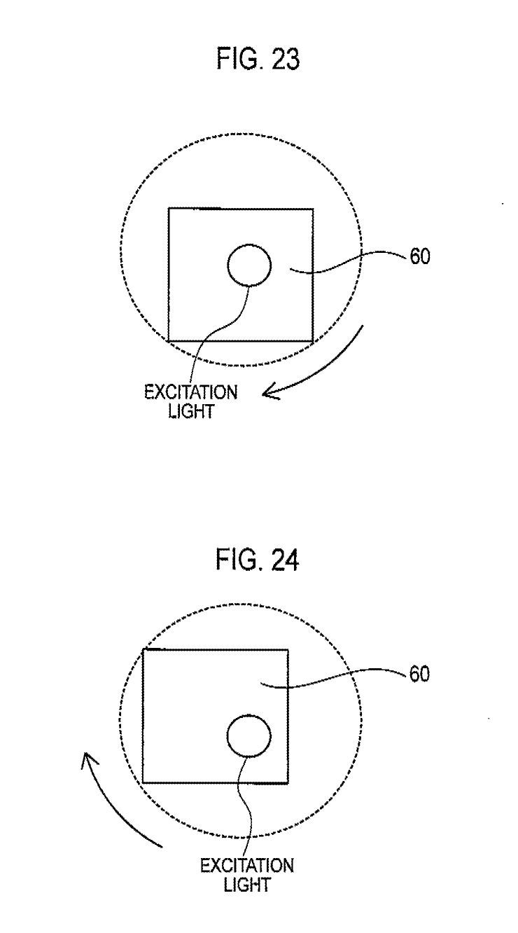

In the fourth modification, the luminous body unit 60 arranged in the end of the tapered rod 150 is configured so as to be swingable. Specifically, as illustrated in FIGS. 21 to 24, the luminous body unit 60 is configured so as to be swingable in a circular form around an irradiation position of excitation light on a certain plane. The term “swingale” may be considered as a term “vibratile”

### (Operation and Effect)

In the fourth modification, the luminous body unit 60 is configured so as to be swingable, thereby shifting the irradiation position of excitation light. This restrains the luminous body 61G from generating heat in association with irradiation of excitation light. Furthermore, the fourth modification saves more space in shifting the irradiation position of excitation light at the luminous body unit 60, compared with a case of using a general rotating wheel which is rotatably configured.

### Second Embodiment

Hereinafter, a projection display apparatus according to a second embodiment is described with reference to drawings. The second embodiment describes a case with the application of the light source apparatus 100 according to any of the first embodiment and the first to fourth modifications. It is noted that the second embodiment describes as an example, a case where the blue component light B is utilized as excitation light.

### (Projection Display Apparatus)

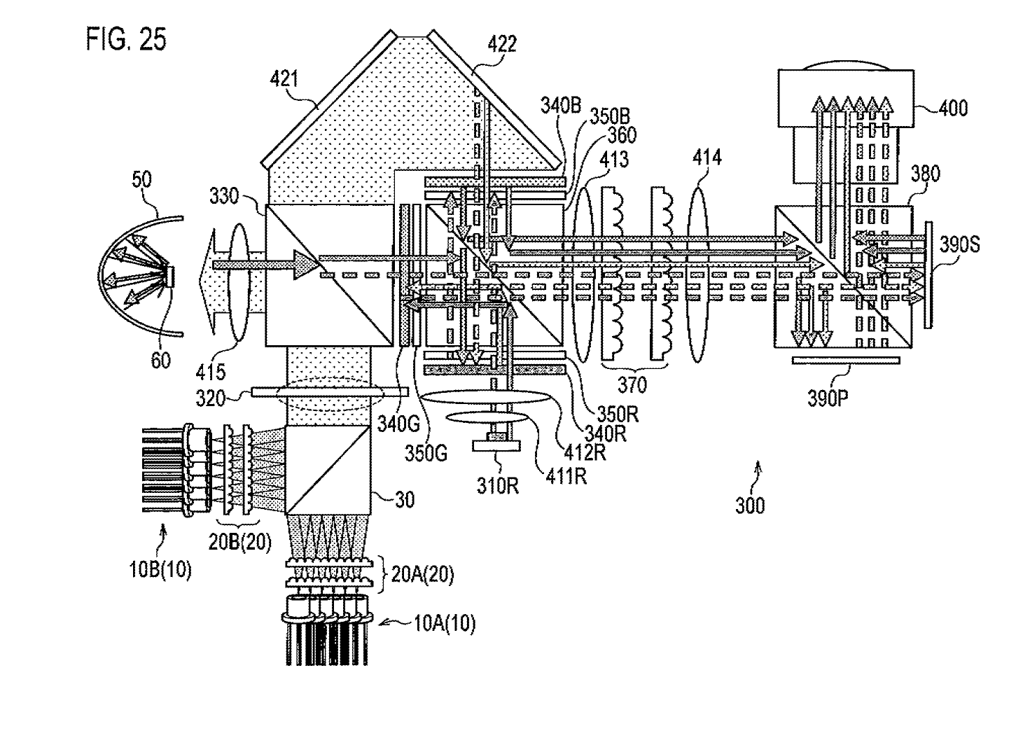

Hereinafter, the projection display apparatus according to the second embodiment is described with reference to drawings. FIG. 25 is a diagram illustrating a projection display apparatus 300 according to the second embodiment. In FIG. 25, explained is a case where the light source apparatus 100 according to the first embodiment is utilized. Therefore, explanation for the light source apparatus 100 is omitted.

The projection display apparatus 300 includes a light source 310R, a polarization modulation element 320, a separation optical element 330, a dichroic mirror 340 (a diachronic mirror 340R, a dichroic mirror 340G, and a dichroic mirror 340B), a ¼ plate 350 (a ¼ plate 350R, a ¼ plate 350G, and a ¼ plate 350B), a PBS cube 360, a fly eye lens unit 370, a PBS cube 380, a projection liquid crystal panel 390P, a reflection liquid crystal panel 390S, and a projection unit 400.

The light source 310R emits the red component light R as fundamental image light. Examples of the light source 310R include an LD (Laser Diode) and LED (Light Emitting Diode).

The polarization modulation element 320 modulates a polarization state of the blue component light B. Specifically, the polarization modulation element 320 modulates a modulation state of the blue component light B in accordance with a value of voltage applied to the polarization modulation element 320.

For example, the polarization modulation element 320 modulates all the blue component light B emitted therefrom to a P-polarization component. Alternatively, the polarization modulation element 320 modulates all the blue component light B emitted therefrom to an S-polarization component. The polarization modulation element 320 may modulate the blue component light B emitted therefrom with a ratio of the P-polarization component to S polarization component set within a range between 0 to 100%.

The separation optical element 330 separates an optical path of the blue component light B emitted from the light source 310B. Specifically, the separation optical element 330 separates an optical path of the blue component light B emitted from the light source 310B into two light paths. One is an optical path using the blue component light B as excitation light while the other is an optical path using the blue component light B as fundamental image light.

The dichroic mirror 340R transmits the red component light R while reflecting another color component light. The dichroic mirror 340G transmits the green component light G while reflecting another color component light. The dichroic mirror 340B transmits the blue component light B while reflecting another color component light.

The ¼ plate 350R transmits color component light which is incident thereon, by rotating polarization of this color component light by 45 degrees. The ¼ plate 350G transmits color component light which is incident thereon, by rotating its polarization by 45 degrees. The ¼ plate 350B transmits color component light which is incident thereon, by rotating polarization of this color component light by 45 degrees.

The PBS cube 360 transmits P-polarized color component light while reflecting S-polarized color component light. Therefore, the PBS cube 360 transmits to the dichroic mirror 340B side, the P-polarized red component light R and green component light G which are incident from the dichroic mirror 340R. On the other hand, the PBS cube 360 reflects to the dichroic mirror 340G side, the S-polarized red component light R and blue component light which are incident from the diachronic mirror 340R.

The PBS cube 360 transmits to the fly eye lens unit 370 side, the P-polarized red component light R, green component light G, and blue component light B, which are incident from the dichroic mirror 340G. On the other hand, the PBS cube 360 reflects to the dichroic mirror 340R, the S-polarized green component light G which is incident from the dichroic mirror 340G.

The PBS cube 360 transmits to the dichroic mirror 340R side, the P-polarized blue component light B which is incident from the dichroic mirror 340B side. On the other hand, the PBS cube 360 transmits to the fly eye lens unit 370 side, the S-polarized red component light R, green component light G, and blue component light B, which are incident from the dichroic mirror 340B.

As described above, the PBS cube 360 emits the P-polarized red component light R, green component light G, and blue component light B while emitting the S-polarized red component light R, green component light G, and blue component light B.

The fly eye lens unit 370 is configured by the plurality of micro-lenses and each of the micro-lenses focuses each color component light so that the reflection liquid crystal panel 390P (or the reflection liquid crystal panel 390S) can be irradiated with each color component light.

The PBS cube 380 transmits the P-polarized color component light while reflecting the S-polarized color component light. Therefore, the PBS cube 380 transmits to the reflection liquid crystal panel 390S side, the P-polarized color component light which is incident on the PBS cube 380. On the other hand, the PBS cube 380 reflects to the reflection liquid crystal panel 390S side, the S-polarized color component light which is incident on the PBS cube 380.

The PBS cube 380 transmits to the projection unit 400 side, the P-polarized color component light which is emitted from the reflection liquid crystal panel 390P. On the other hand, the PBS cube 380 reflects to the projection unit 400 side, the S-polarized color component light which is emitted from the reflection liquid crystal panel 390S.

The reflection liquid crystal panel 390P modulates the S-polarized color component light while emitting only the P-polarized color component light. On the other hand, the reflection liquid crystal panel 390S modulates the P-polarized color component light while emitting only the S-polarized color component light.

The projection unit 400 projects on a projection surface, light (image light) emitted from the reflection liquid crystal panel 390P and the reflection liquid crystal panel 390S.

In the projection display apparatus 300 described above, the S-polarized color component light and the P-polarized color component light are separately modulated, so that a three-dimensional image can be displayed.

It goes without saying that the projection display apparatus 300 includes a necessary lens group (a lens 411R, a lens 412R, and a lens 413R to a lens 415). Furthermore, it also goes without saying that the projection display apparatus 300 includes a necessary mirror group (a mirror 421 and a mirror 422).

### [First Modification]

Hereinafter, a first modification of the second embodiment is explained. The explanation below is based primarily on the differences with respect to the second embodiment.

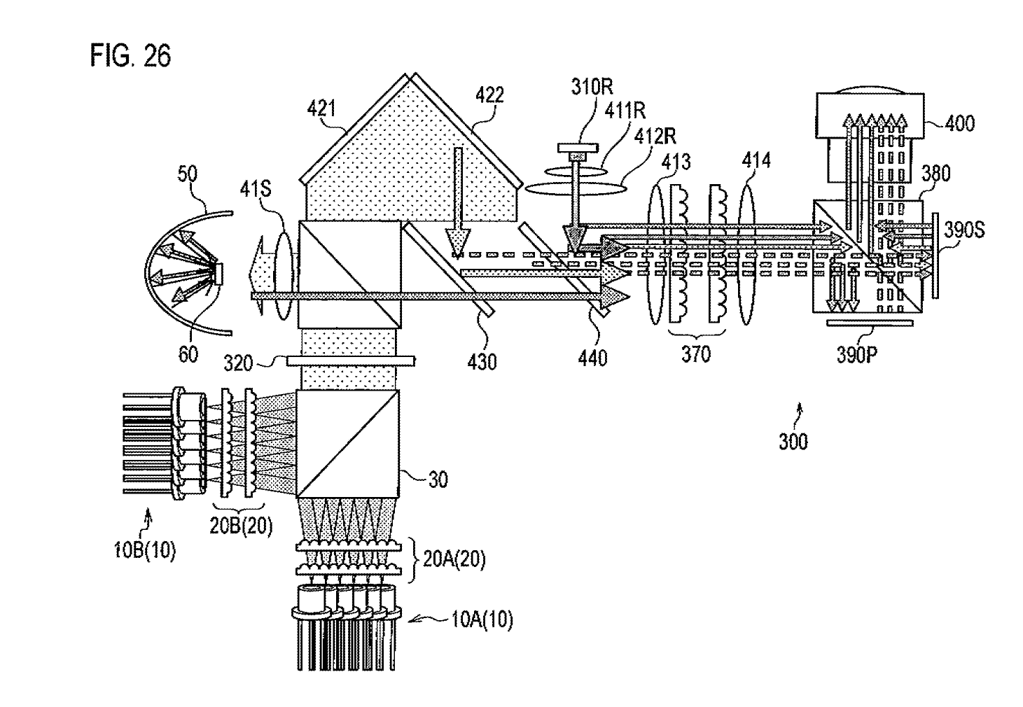

In the first modification, as illustrated in FIG. 26, the light source 310R is disposed differently. Furthermore, the projection display apparatus 300 includes a dichroic mirror 430 and a dichroic mirror 440 instead of the dichroic mirror 340, the ¼ plate 350, and the PBS cube 360.

The dichroic mirror 430 transmits the green component light G while reflecting the blue component light B. The dichroic mirror 440 transmits the green component light G and the blue component light B which are emitted from the dichroic mirror 430, while reflecting the red component light R which is emitted from the light source 310R.

### [Second Modification]

Hereinafter, a second modification of the second embodiment is explained. The explanation below is based primarily on the differences with respect to the second embodiment.

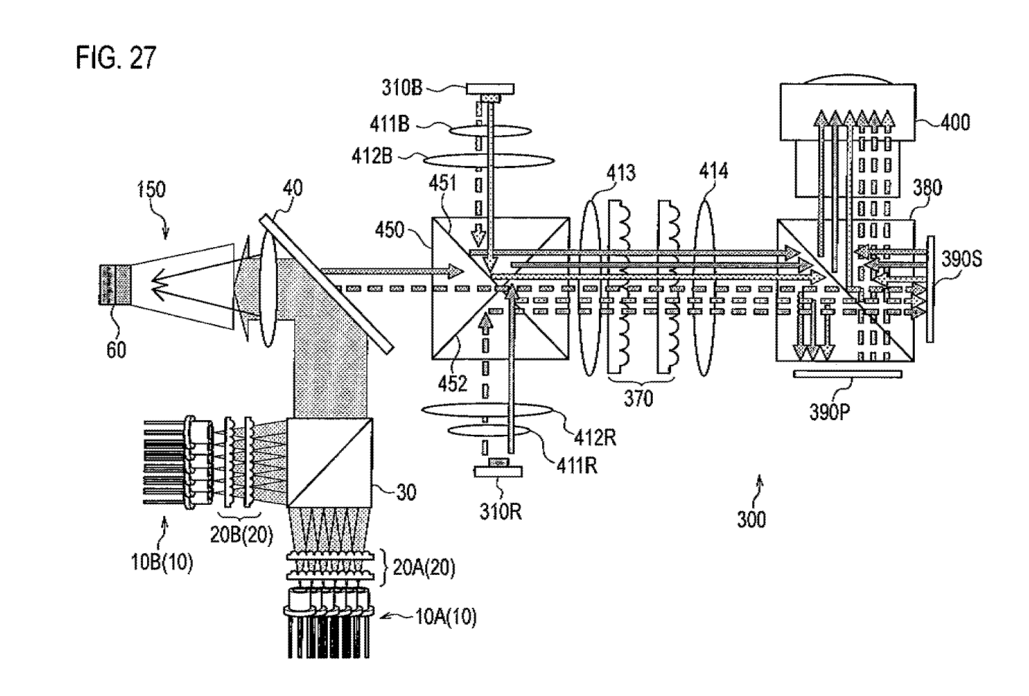

In the second modification, as illustrated in FIG. 27, the light source 310B is arranged in addition to the light source 310R. Furthermore, the light source 100 according to the third modification (or the fourth modification) of the first embodiment is utilized. Yet further, the projection display apparatus 300 includes a cross dichroic cube 450 instead of the dicroic mirror 340, the ¼ plate 350, and the PBS cube 360.

The light source 310B emits the blue component light B as fundamental image light. Examples of the light source 310B include an LD (Laser Diode) and LED (Light Emitting Diode).

The cross dicroic cube 450 includes a dicroic surface 451 and a dicroic surface 452. The dichroic surface 451 transmits the red component light R and the green component light G while reflecting the blue component light B. The dichroic surface 452 transmits the green component light G and the blue component light B while reflecting the red component light R.

It is noted that, in the projection display apparatus 300, a necessary configuration (such as a lens 411B and a lens 412B) is added while an unnecessary configuration (such as the mirror 421 and the mirror 422) is omitted with respect to a configuration illustrated in FIG. 25.

### [Third Modification]

Hereinafter, a third modification of the second embodiment is explained. The explanation below is based primarily on the differences with respect to the second embodiment.

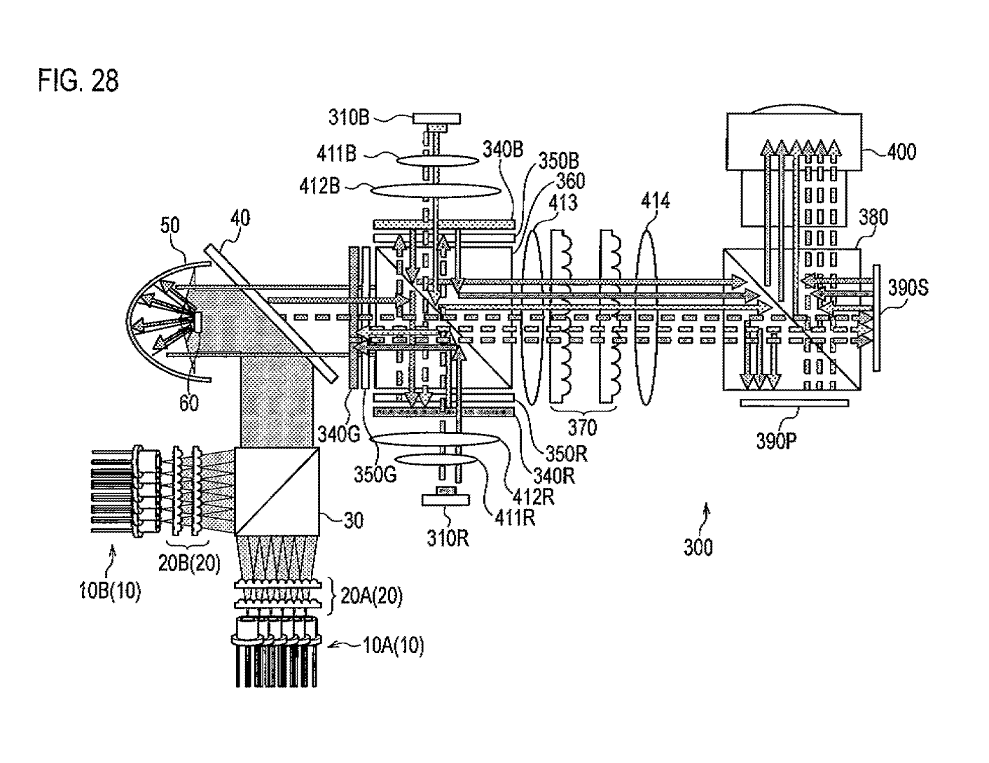

In the third modification, as illustrated in FIG. 28, the light source 310B is arranged in addition to the light source 310R. The projection display apparatus 300 includes the light guiding reflection mirror 40 instead of the separation optical element 330.

The light source 310B emits the blue component light B as fundamental image light. Examples of the light source 310B include an LD (Laser Diode) and LED (Light Emitting Diode).

It is to be noted that, in the projection display apparatus 300, a necessary configuration (such as the lens 411B and the lens 412B) is added while an unnecessary configuration (such as the mirror 421 and the mirror 422) is omitted with respect to a configuration illustrated in FIG. 25.

### [Fourth Modification]

Hereinafter, a fourth modification of the second embodiment is explained. The explanation below is based primarily on the differences with respect to the second embodiment.

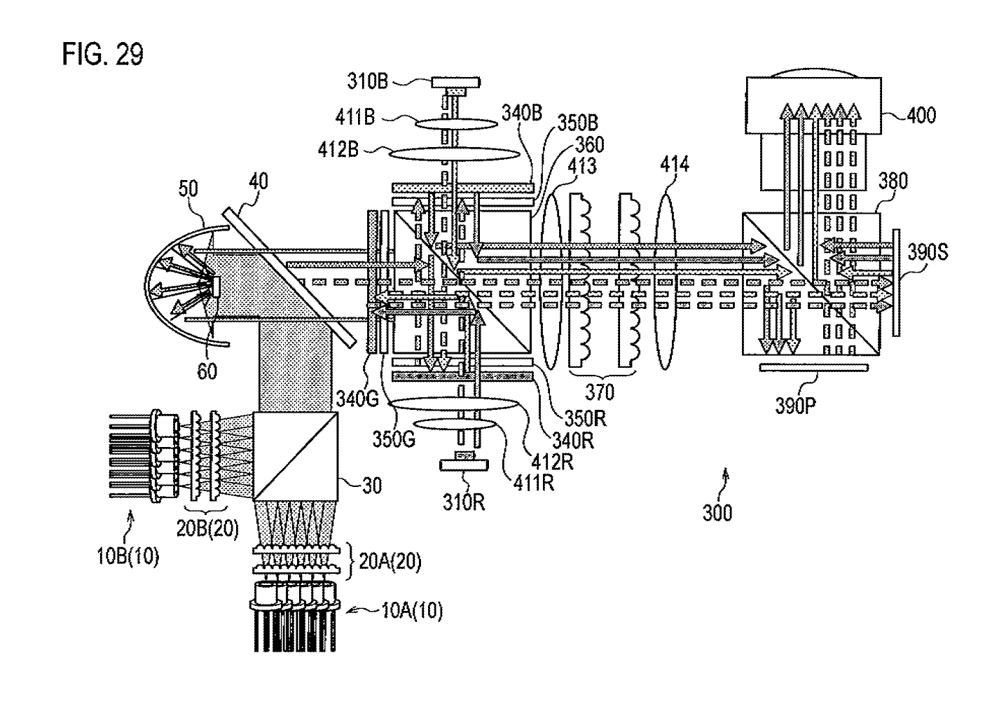

In the fourth modification, as illustrated in FIG. 29, a DIVED 480 is arranged instead of the reflection liquid crystal panel 390P and the reflection liquid crystal panel 390S. Furthermore, the projection display apparatus 300 includes a rod integrator 460 instead of the fly eye lens unit 370, and a reflection mirror 470 instead of the PBS cube 380.

The rod integrator 460 is configured by a transparent member such as glass while having a rod shape. Specifically, the rod integrator 460 includes a light incidence surface, a light emission surface, and a light reflecting side surface arranged from the light incidence surface to the light emission surface. The rod integrator 460 equalizes light which is incident thereon.

The reflection mirror 470 reflects to the DMD 480 side, light emitted from the rod integrator 460.

The DMD 480 is configured by the plurality of micro-mirrors, and these plurality of micro-mirrors are movable. Basically, each of the micro-mirrors corresponds to one pixel. The DMD 480 changes an angle of each micro-mirror so as to switch whether or not to reflect light on the projection unit 400 side.

### Other Embodiments

The present invention is explained through the above embodiment, but it must not be assumed that this invention is limited by the statements and drawings constituting a part of this disclosure. From this disclosure, various alternative embodiments, examples and operational technologies will become apparent to those skilled in the art.

Described as an example in the embodiment is a case where two light source units are arranged. However, the embodiment is not limited thereto. For example, a single light source unit or three or more light source units may be arranged.

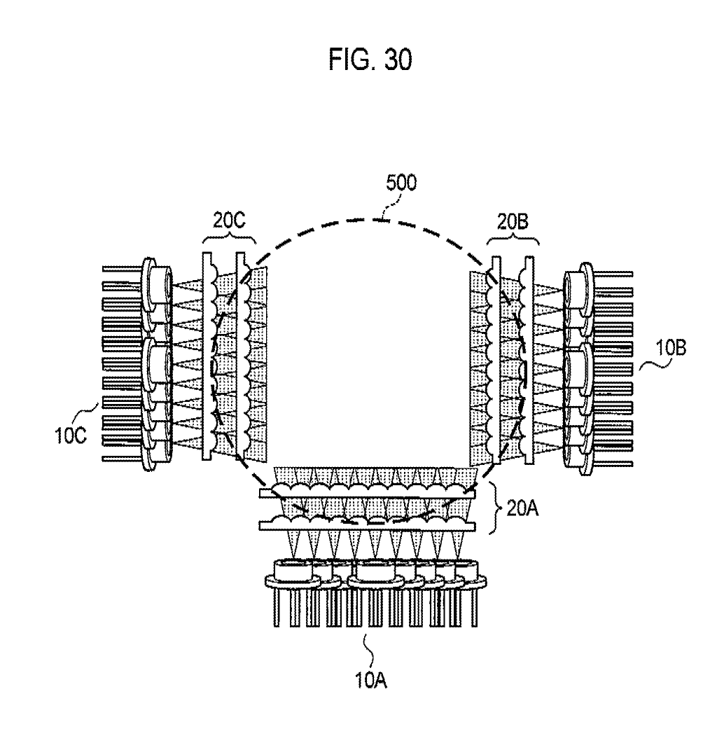

For example, as illustrated in FIG. 30, a case where light source units 10A to 100 are arranged is explained. It is noted the fly eye lens units 20A to 20C are arranged in accordance with the light source units 10A to 10C, respectively.

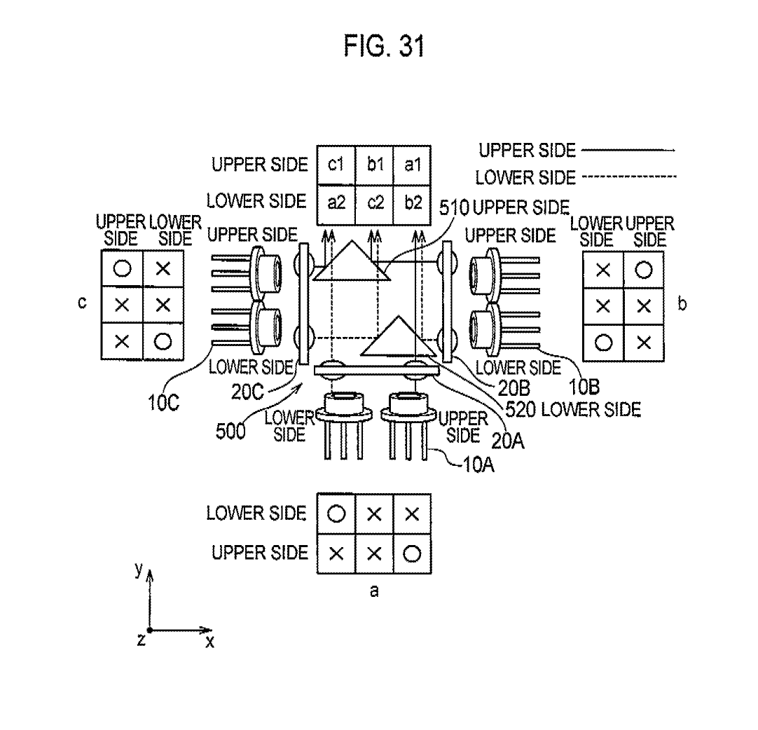

In such a case, a combining element 500 combines light emitted from the light source units 10A to 10C includes an upper side mirror 510 and a lower side mirror 520, as illustrated in FIG. 31. In a case of expressing a space with three axes (an x-axis, a y-axis, and a z-axis), all of coordinates on the x-axis, the y-axis, and the z-axis are different between the upper side mirror 510 and the lower side mirror 520.

With disposition described above, the upper side mirror 510 reflects on a position “b1.”, light emitted from a light source arranged in an upper row of the light source unit 10B while reflecting on a position “c1”, light emitted from a light source arranged in an upper row of the light source unit 10C. The lower side mirror 520 reflects on a position “b2”, light emitted from a light source arranged in a lower row of the light source unit 10B while reflecting on a position “c2”, light emitted from a light source arranged in a lower row of the light source unit 10C. It is noted that, light emitted from a light source arranged in an upper row of the light source unit 10A is guided to a position “a1” without being interfered with the lower side mirror 520 while light emitted from a light source arranged in a lower row of the light source unit 10A is guided to a position “a2” without being interfered with the upper side mirror 510.

As described above, light emitted from the light source units 10A to 10C can be combined by adapting positions of light sources arranged in these three light source units.

In the embodiment, the DMD 480 is described as an example of an imager. However, the embodiment is not limited thereto. The imager may be a single liquid crystal panel or three liquid crystal panels (a red liquid crystal panel, a green liquid crystal panel, and a blue liquid crystal panel). The liquid crystal panel may be a transmissive type or may be a reflective type.

In the embodiment, described as an example is a configuration for the light guiding reflection surface in which excitation light is reflected and fundamental image light is transmitted. However, the embodiment is not limited thereto. The light guiding reflection surface may adapt such a configuration in which excitation light is transmitted and fundamental image light is reflected.

1. A light source apparatus comprising:
a light source unit including a plurality of light sources that emits excitation light;
a light guiding reflection mirror including a light guiding reflection surface that reflects the excitation light emitted from the light source unit;
a reflector including a reflection surface that reflects the excitation light reflected by the light guiding reflection mirror; and
a luminous body unit arranged in vicinity to a focal point position of the reflector, wherein the luminous body unit includes:
a luminous body that emits fundamental image light in accordance with the excitation light reflected by the reflector; and
a reflecting body that reflects to a side of the reflector, the fundamental image light emitted from the luminous body,
the reflection surface reflects to a side of the light guiding reflection mirror, the fundamental image light reflected by the reflecting body,
the light guiding reflection surface transmits the fundamental image light reflected by the reflecting surface, and
the plurality of light sources are disposed around a position corresponding to an axis on which the luminous body unit is disposed.

2. A light source apparatus comprising:
a light source unit including a plurality of light sources that emits excitation light;
a light guiding reflection mirror including a light guiding reflection surface that reflects the excitation light emitted from the light source unit;
a tapered rod arranged on an optical path of the excitation light reflected by the light guiding reflection mirror, the tapered rod including an incidence end on which the excitation light is incident and an emission end from which the excitation light is emitted; and
a luminous body unit arranged in the emission end, wherein
the luminous body unit includes:
a luminous body that emits fundamental image light in accordance with excitation light reflected by the light guiding refection mirror; and
a reflecting body that reflects to a side of the light guiding reflection mirror, the fundamental image light emitted from the luminous body,
the light guiding reflection surface transmits the fundamental image light reflected by the reflecting body, and
the plurality of light sources are disposed around a position corresponding to an axis on which the luminous body unit is disposed.

3. The light source apparatus according to claim 1 or claim 2, further comprising:
a lens unit including a plurality of lenses that focuses the excitation light emitted from the light source unit, wherein
the plurality of lenses are disposed around the position corresponding to the axis on which the luminous body unit is disposed, and
the plurality of lenses correspond to the plurality of light sources, respectively.

4. The light source apparatus according to claim 1, wherein
the light source unit is configured by a first light source unit and a second light source unit, the first light source unit including a plurality of first light sources that emits first polarized excitation light, the second light source unit including a plurality of second light sources that emit second polarized excitation light,
a combining unit combines the first polarized excitation light emitted from the first light source unit and the second polarized excitation light emitted from the second light source unit, and is arranged on an optical path of excitation light emitted from the light source unit, between the light source unit and the light guiding reflection mirror, and
the plurality of first light sources and the plurality of second light sources are disposed so that the first polarized excitation light and the second polarized excitation light are alternately arranged in a circular form around the position corresponding to the axis on which the luminous body unit is disposed, after the lights are combined by the combining unit.

5. The light source apparatus according to claim 1, wherein the luminous body unit is configured by a rotating drum or a rotating wheel that supports the luminous body in a rotatable manner.

6. The light source apparatus according to claim 3, wherein
the luminous body unit is configured by a swinging body that supports the luminous body in a swingable manner in accordance with a position on which the excitation light is focused by the lens unit.

7. A projection display apparatus comprising:
the light source apparatus according to claim 1;
an imager that modulates light emitted from the light source apparatus; and
a projection unit that projects light emitted from the imager.

8. The light source apparatus according to claim 2, further comprising:
a lens unit including a plurality of lenses that focuses the excitation light emitted from the light source unit, wherein
the plurality of lenses are disposed around the position corresponding to the axis on which the luminous body unit is disposed, and
the plurality of lenses correspond to the plurality of light sources, respectively.

9. The light source apparatus according to claim 2, wherein
the light source unit is configured by a first light source unit and a second light source unit, the first light source unit including a plurality of first light sources that emits first polarized excitation light, the second light source unit including a plurality of second light sources that emit second polarized excitation light,
a combining unit combines the first polarized excitation light emitted from the first light source unit and the second polarized excitation light emitted from the second light source unit, and is arranged on an optical path of excitation light emitted from the light source unit, between the light source unit and the light guiding reflection mirror, and
the plurality of first light sources and the plurality of second light sources are disposed so that the first polarized excitation light and the second polarized excitation light are alternately arranged in a circular form around the position corresponding to the axis on which the luminous body unit is disposed, after the lights are combined by the combining unit.

10. The light source apparatus according to claim 2, wherein
the luminous body unit is configured by a rotating drum or a rotating wheel that supports the luminous body in a rotatable manner.

11. A projection display apparatus comprising:
the light source apparatus according to claim 2;
an imager that modulates light emitted from the light source apparatus; and
a projection unit that projects light emitted from the imager.

12. The light source apparatus according to claim 8, wherein
the luminous body unit is configured by a swinging body that supports the luminous body in a swingable manner in accordance with a position on which the excitation light is focused by the lens unit.
